(19) United States
(12) Patent Application Publication
(10) Pub. No.: US 2025/0214055 A1
(43) Pub. Date: Jul. 3, 2025

(54) CERAMIC ELECTRODE STRUCTURE AND OZONE GENERATOR

(71) Applicant: INDUSTRIAL TECHNOLOGY RESEARCH INSTITUTE, Hsinchu (TW)

(72) Inventors: Tune-Hune KAO, Hsinchu City (TW); Jie-Chi CHEN, Taoyuan City (TW); Meng-Chi HUANG, Taoyuan City (TW)

(73) Assignee: INDUSTRIAL TECHNOLOGY RESEARCH INSTITUTE, Hsinchu (TW)

(21) Appl. No.: 18/596,441

(22) Filed: Mar. 5, 2024

(30) Foreign Application Priority Data
Jan. 3, 2024 (TW) 113100241

(51) Int. Cl. B01J 19/08; C01B 13/11

(52) U.S. Cl. CPC B01J 19/088; C01B 13/115; B01J 2219/0835; B01J 2219/0841; C01B 2201/22; C01B 2201/24; C01B 2201/32

(57) ABSTRACT

This disclose provides a ceramic electrode structure including a first ceramic body, a second ceramic body, a metal electrode, and an inorganic bonding material. The second ceramic body is disposed to be corresponding to the first ceramic body. The metal electrode is disposed between the first ceramic body and the second ceramic body. The inorganic bonding material is filled in a gap between the first ceramic body and the second ceramic body and surrounds the metal electrode. The second ceramic body is bent to have a concave surface facing the first ceramic body and a convex surface that is opposite to the concave surface. A plurality of components of the inorganic bonding material comprise oxygen, sodium, magnesium, calcium, aluminum and silicon.

### CROSS-REFERENCE TO RELATED APPLICATIONS

All related applications are incorporated by reference. The present application is based on, and claims priority from, Taiwan (International) application No. 113100241 filed on Jan. 3, 2024, the disclosure of which is hereby incorporated by reference herein in its entirety.

### TECHNICAL FIELD

The disclosure relates to a ceramic electrode structure and an ozone generator including the same.

### BACKGROUND

In general, an ozone generator generates ozone by a high-voltage current flowing through a ceramic electrode and a tungsten electrode thereof. The ozone generator has been widely applied in deodorization, sterilization and air purification.

Recently, with the development of the advanced semiconductor fabrication (e.g., a fabrication of 5 nm chip or smaller chip) and structures having high aspect ratio, the conventional solution producing a silicon oxide layer as an electrically insulated layer or a protective layer by heating has become inapplicable. Currently, a new semiconductor fabrication that prepares the silicon oxide layer by the silicon dioxide produced by the reaction between the tetraethoxysilane (TEOS) and the ozone is proposed.

### SUMMARY

One embodiment of this disclosure provides a ceramic electrode structure including a first ceramic body, a second ceramic body, a metal electrode, and an inorganic bonding material. The second ceramic body is disposed to be corresponding to the first ceramic body. The metal electrode is disposed between the first ceramic body and the second ceramic body. The inorganic bonding material is filled in a gap between the first ceramic body and the second ceramic body and surrounds the metal electrode. The second ceramic body is bent to have a concave surface facing the first ceramic body and a convex surface that is opposite to the concave surface. A plurality of components of the inorganic bonding material comprise oxygen, sodium, magnesium, calcium, aluminum and silicon. A weight percentage of oxygen in the inorganic bonding material ranges from 30.0% to 50.0%. A weight percentage of sodium in the inorganic bonding material ranges from 10.0% to 20.0%. A weight percentage of magnesium in the inorganic bonding material is equal to or less than 10.0%. A weight percentage of calcium in the inorganic bonding material is equal to or less than 10.0%. A weight percentage of aluminum in the inorganic bonding material ranges from 1.0% to 5.0%. A weight percentage of silicon in the inorganic bonding material is equal to or less than 30.0%.

Another embodiment of this disclosure provides an ozone generator including the above ceramic electrode structure.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a schematic view of a ceramic electrode structure according to a first embodiment of the disclosure;

FIG. 2 is a top schematic view of a bottom part of the ceramic electrode structure in FIG. 1;

FIG. 3 is a bottom schematic view of a top part of the ceramic electrode structure in FIG. 1;

FIG. 4 is a schematic view showing a manufacture of the ceramic electrode structure in FIG. 1;

FIG. 5 is an electron microscope image of a region 5-5 of the ceramic electrode structure in FIG. 1;

FIG. 6 is an electron microscope image of a region 6-6 of the ceramic electrode structure in FIG. 1;

FIG. 7 is a schematic view of a ceramic electrode structure according to a second embodiment of the disclosure;

FIG. 8 is a schematic view showing a manufacture of the ceramic electrode structure in FIG. 7; and

FIG. 9 is a schematic view of an ozone generator according to one embodiment of the disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

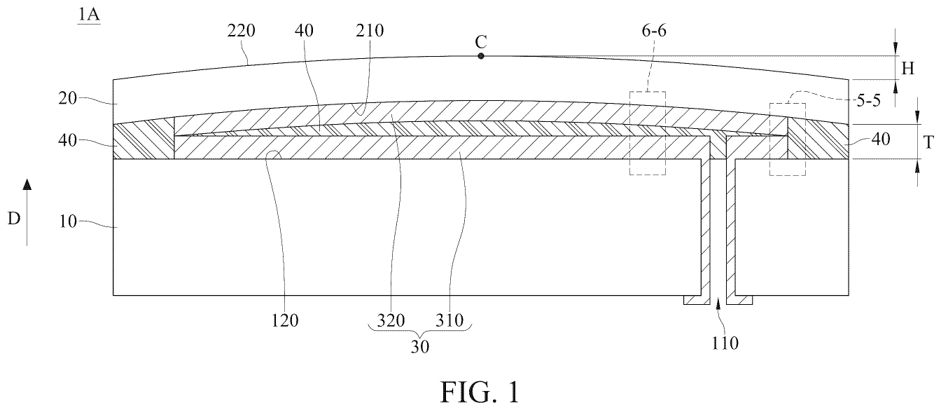

Please refer to FIG. 1 that is a schematic view of a ceramic electrode structure 1A according to a first embodiment of the disclosure. In this embodiment, the ceramic electrode structure 1A includes a first ceramic body 10, a second ceramic body 20, a metal electrode 30 and an inorganic bonding material 40. The first ceramic body 10, the metal electrode 30 and the second ceramic body 20 are sequentially disposed along a stacking direction D.

The first ceramic body 10 and the second ceramic body 20 are disposed to be corresponding to each other. In this embodiment, each of the first ceramic body 10 and the second ceramic body 20 may be made by aluminum oxide, aluminum nitride, zirconium oxide, perovskite or barium titanate.

The metal electrode 30 is disposed between the first ceramic body 10 and the second ceramic body 20. In this embodiment, the metal electrode 30 may include a first metal layer 310 and a second metal layer 320. The first metal layer 310 is bonded to the first ceramic body 10, the second metal layer 320 is bonded to the second ceramic body 20, and the first metal layer 310 and the second metal layer 320 are in contact with each other. Each of the first metal layer 310 and the second metal layer 320 may be made by silver, gold, aluminum or copper. The first metal layer 310 and the second metal layer 320 may be formed on the first ceramic body 10 and the first ceramic body 10 by screen printing and sintering, respectively.

The inorganic bonding material 40 is filled in a gap between the first ceramic body 10 and the second ceramic body 20, and the inorganic bonding material 40 surrounds the first metal layer 310 and the second metal layer 320 of the metal electrode 30. The inorganic bonding material 40 may be made by a material similar to ceramic that has a melting point lower than that of the ceramic, which will be described in detail hereinafter.

In this embodiment, the second ceramic body 20 is bent to cause a curvature thereof. As shown in FIG. 1, the second ceramic body 20 is bent and thus has a concave surface 210 facing the first ceramic body 10 and a convex surface 220 opposite to the concave surface 210. In the stacking direction D, a vertical distance H between a critical point C of the convex surface 220 and an edge of the convex surface 220 may range from 30.0 micrometers (μm) to 90.0 μm. The critical point C is a point of tangency where the convex surface 220 meets a tangent plane perpendicular to the stacking direction D, and the critical point C may be located on a center of the convex surface 220.

In this embodiment, a thickness of the first ceramic body 10 in the stacking direction D may be larger than a thickness of the second ceramic body 20 in the stacking direction D. The thickness of the first ceramic body 10 may be at least three times larger than the thickness of the second ceramic body 20. Accordingly, the heat dissipation efficiency of the first ceramic body 10 is improved.

In this embodiment, the first ceramic body 10 may have a through hole 110. A part of the first metal layer 310 of the metal electrode 30 extends into the through hole 110. The through hole 110 may accommodate a probe from external device, such that current and voltage is allowed to be applied to the metal electrode 30 from the probe.

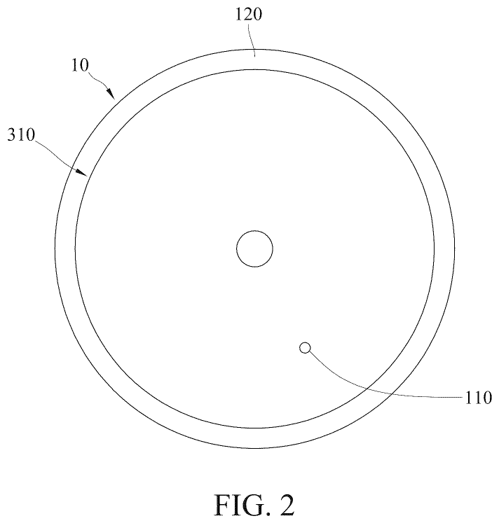

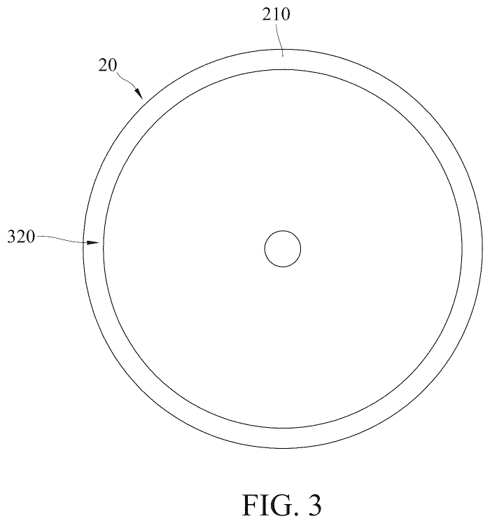

Each metal layer may have an area that is large enough to realize creeping discharge on a region of large area. In this embodiment, the first ceramic body 10 has an inner surface 120 facing the second ceramic body 20. An orthogonal projection of the first metal layer 310 of the metal electrode 30 onto the inner surface 120 may occupy 70.0% to 95.0% of the inner surface 120. That is, an area of the said orthogonal projection may be 70.0% to 95.0% of an area of the inner surface 120. FIG. 2 is a top schematic view of a bottom part of the ceramic electrode structure 1A in FIG. 1. In FIG. 2, the orthogonal projection of the first metal layer 310 onto the inner surface 120 may occupy 83.0% of the inner surface 120. In this embodiment, an orthogonal projection of the second metal layer 320 of the metal electrode 30 onto the concave surface 210 of the second ceramic body 20 may occupy 70.0% to 95.0% of the concave surface 210. FIG. 3 is a bottom schematic view of a top part of the ceramic electrode structure 1A in FIG. 1. In FIG. 3, the orthogonal projection of the second metal layer 320 onto the concave surface 210 may occupy 83.0% of the concave surface 210.

In this embodiment, the components of the inorganic bonding material 40 include oxygen (O), sodium (Na), magnesium (Mg), calcium (Ca), aluminum (Al) and silicon (Si). The components of the inorganic bonding material 40 may further include at least one of Zirconium (Zr), potassium (K) and lead (Pb). A weight percentage of oxygen in the inorganic bonding material 40 ranges from 30.0% to 50.0%, a weight percentage of sodium in the inorganic bonding material 40 ranges from 10.0% to 20.0%, a weight percentage of magnesium in the inorganic bonding material 40 is equal to or less than 10.0%, a weight percentage of calcium in the inorganic bonding material 40 is equal to or less than 10.0%, a weight percentage of aluminum in the inorganic bonding material 40 ranges from 1.0% to 5.0%, and a weight percentage of silicon in the inorganic bonding material 40 is equal to or less than 30.0%. The components of the inorganic bonding material 40 may include 45.0% of oxygen, 16.0% of sodium, 3.50% of magnesium, 4.50% of calcium, 3.0% of aluminum and 17.0% of silicon.

The inorganic bonding material 40 including the said weight percentage of elements provides high hardness and low melting point. In detail, the melting point of the inorganic bonding material may be lower than 600.0° C., and the melting point of each of the first ceramic body 10 and the second ceramic body 20 may be 1200.0° C. The Vickers hardness of the inorganic bonding material 40 may range from 1000.0 to 1500.0. The dielectric strength of the inorganic bonding material 40 may be higher than 15.0 KV/mm.

In the components of the inorganic bonding material 40 disclosed by this embodiment, the weight percentage of magnesium in the inorganic bonding material 40 may range from 2.0% to 10.0%, and the weight percentage of calcium in the inorganic bonding material 40 may range from 2.0% to 10.0%. If the weight percentages of magnesium and calcium exceeds 10.0%, the melting point of the inorganic bonding material 40 may be up to, for example, 700.0° C.

In the components of the inorganic bonding material 40 disclosed by this embodiment, the weight percentage of oxygen in the inorganic bonding material 40 may range from 30.0% to 40.0%, and the weight percentage of silicon in the inorganic bonding material 40 may range from 10.0% to 30.0%, If the weight percentage of oxygen exceeds 40.0% or the weight percentage of silicon exceeds 30.0%, the hardness (e.g., Vickers hardness) of the inorganic bonding material 40 may be equal to or less than 800.0.

In this embodiment, a minimum thickness T of the inorganic bonding material 40 in the stacking direction D may range from 10.0 μm to 40.0 μm. In more detail, in a side part of the ceramic electrode structure 1A, the thickness of the inorganic bonding material 40 may range from 10.0 μm to 40.0 μm. The minimum thickness T of the inorganic bonding material 40 may be 30.0 μm.

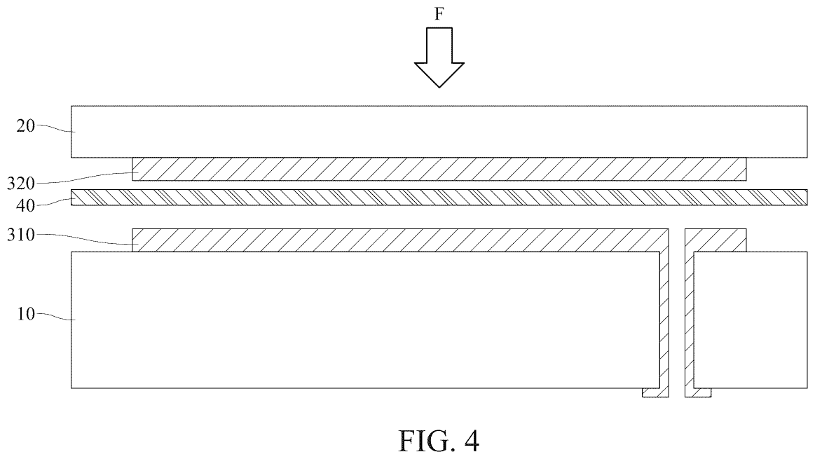

Hereinafter, a manufacturing method of the ceramic electrode structure 1A will be described. FIG. 4 is a schematic view showing a manufacture of the ceramic electrode structure 1A in FIG. 1. The first ceramic body 10 where the first metal layer 310 is disposed, the second ceramic body 20 where the second metal layer 320 is disposed, and the sheet-shaped inorganic bonding material 40 are provided, and the inorganic bonding material 40 is disposed between the first metal layer 310 and the second metal layer 320. An external force F is applied to press the second ceramic body 20 onto the first ceramic body 10, and the inorganic bonding material 40 is heated and thus melts to surround the first metal layer 310 and the second metal layer 320. When the second ceramic body 20 is pressed onto the first ceramic body 10, the second ceramic body 20 may be bent by molding. The temperature for heating the inorganic bonding material 40 to melt may be 580.0° C.

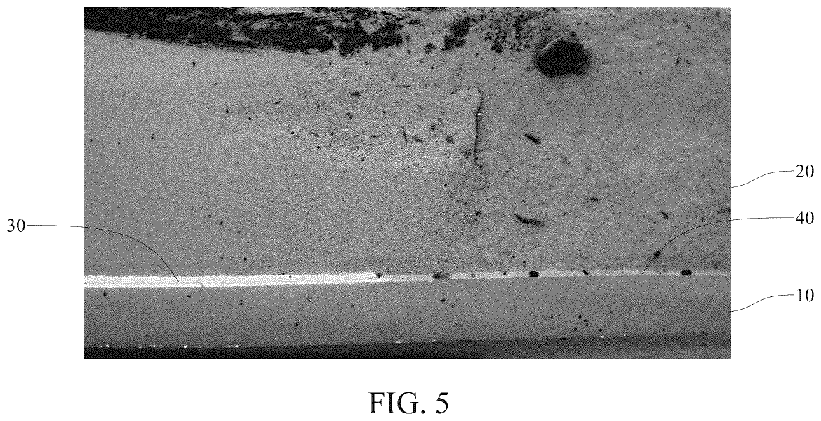

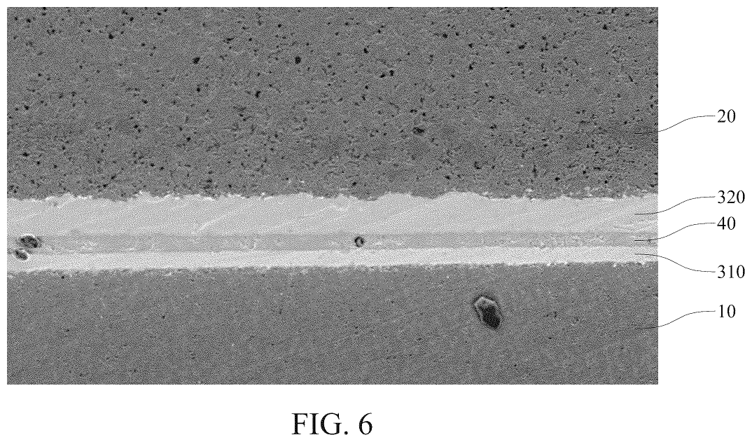

In the components of the inorganic bonding material 40 of this embodiment, the said weight percentages of magnesium and calcium allow the inorganic bonding material 40 to have a coefficient of thermal expansion similar to those of the first ceramic body 10 and the second ceramic body 20. Thus, when the second ceramic body 20 is pressed onto the first ceramic body 10, a crack is prevented from occurring on the thinner second ceramic body 20, thereby preventing the leakage from occurring when a high voltage (e.g., a voltage more than ten thousand volts) is applied. The said weight percentage of oxygen or silicon prevents the Vickers hardness of the inorganic bonding material 40 from being equal to or less than 800.0, thereby preventing a crack or deformation caused by ineffective support of the inorganic bonding material 40 due to the low hardness thereof when the second ceramic body 20 is pressed by the external force. FIG. 5 is an electron microscope image of a region 5-5 of the ceramic electrode structure 1A in FIG. 1, and FIG. 6 is an electron microscope image of a region 6-6 of the ceramic electrode structure 1A in FIG. 1.

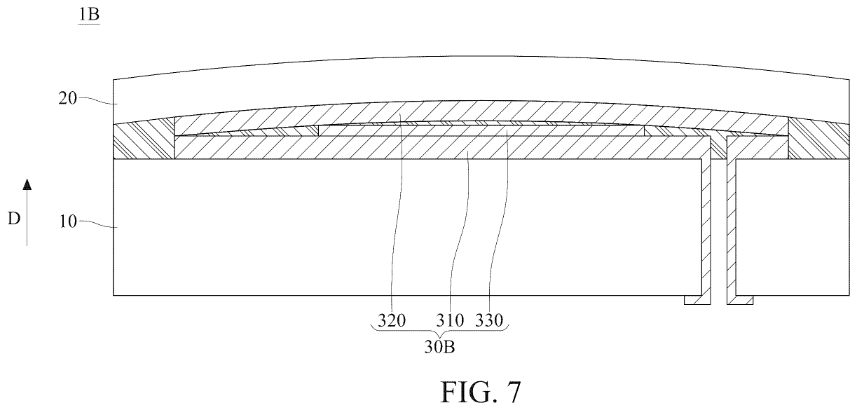

The metal electrode in the ceramic electrode structure of this disclosure is not limited by the configuration shown in FIG. 1. FIG. 7 is a schematic view of a ceramic electrode structure 1B according to a second embodiment of the disclosure. In this embodiment, the ceramic electrode structure 1B includes the first ceramic body 10, the second ceramic body 20, a metal electrode 30B and the inorganic bonding material 40. The ceramic electrode structure 1B of this embodiment is similar to the ceramic electrode structure 1A in FIG. 1, and thus the difference therebetween will be mainly described hereinafter.

As shown in FIG. 7, the metal electrode 30B of the ceramic electrode structure 1B includes the first metal layer 310, the second metal layer 320 and a third metal layer 330. The third metal layer 330 is located between the first metal layer 310 and the second metal layer 320. The first metal layer 310 and the second metal layer 320 are in contact with two opposite sides of the third metal layer 330, respectively. In addition, in a horizontal direction perpendicular to the stacking direction D, a width of the third metal layer 330 is smaller than a width of the first metal layer 310 and a width of the second metal layer 320.

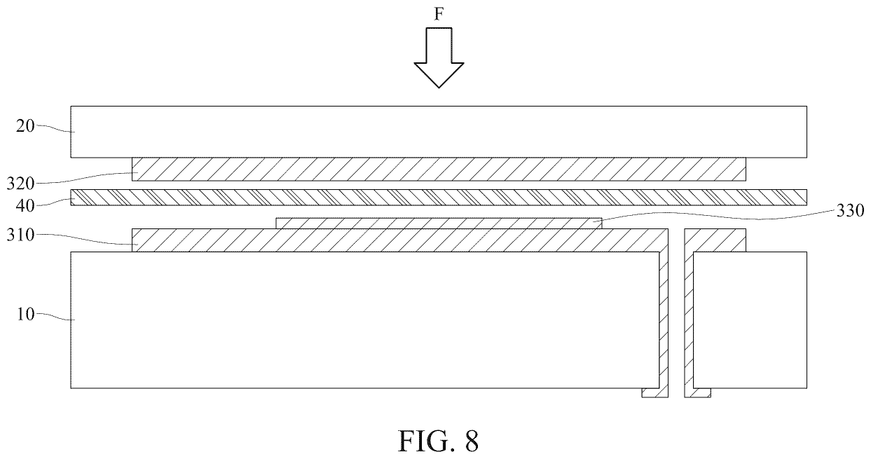

FIG. 8 is a schematic view showing a manufacture of the ceramic electrode structure 1B in FIG. 7. The first ceramic body 10 where the first metal layer 310 is disposed, the second ceramic body 20 where the second metal layer 320 is disposed, the third metal layer 330 and the sheet-shaped inorganic bonding material 40 are provided, and the inorganic bonding material 40 is disposed between the first metal layer 310 and the third metal layer 330. The external force F is applied to press the second ceramic body 20 onto the first ceramic body 10, and the inorganic bonding material 40 is heated and thus melts to surround the first metal layer 310, the second metal layer 320 and the third metal layer 330. When the second ceramic body 20 is pressed onto the first ceramic body 10, the interference between the third metal layer 330 and the second metal layer 320 may allow the second ceramic body 20 to be bent. Further, the third metal layer 330 may support a central part of the second metal layer 320 without supporting a peripheral part of the second metal layer 320, so as to allow the second metal layer 320 to be bent.

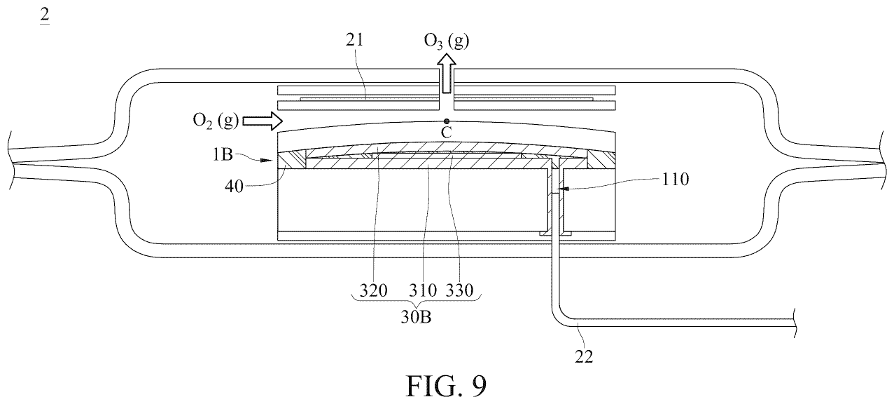

FIG. 9 is a schematic view of an ozone generator 2 according to one embodiment of the disclosure. The ozone generator 2 provided by this embodiment includes a tungsten electrode 21, a metal probe 22 and the aforementioned ceramic electrode structure 1A or ceramic electrode structure 1B. FIG. 9 exemplarily shows that the ozone generator 2 includes the ceramic electrode structure 1B as shown in FIG. 7. The metal probe 22 is inserted into the through hole 110 of the first ceramic body 10 so as to be in contact with the first metal layer 310 of the metal electrode 30B. Oxygen gas (O₂(g)) from the outside is injected into a reaction space between the ceramic electrode structure 1B and the tungsten electrode 21. The metal probe 22 is electrified and applies relative high voltage to the first metal layer 310, and the tungsten electrode 21 has relative low voltage. In this way, the ceramic electrode structure 1B generates corona discharge to produce ozone gas (O₃(g)) by splitting oxygen gas into elemental oxygen. Since the second ceramic body 20 of the ceramic electrode structure 1B is bent to cause a curvature thereof, ozone gradient distribution and pressure difference are formed in the reaction space between the ceramic electrode structure 1B and the tungsten electrode 21. In particular, ozone with high concentration is provided in a region around the critical point C. In addition, the inorganic bonding material 40 has characteristics of high hardness, low melting point, being difficult to be decomposed by ozone and the like, thereby meeting the manufacturing feasibility of the ceramic electrode structure and the application of the ozone generator 2 in semiconductor fabrication.

As discussed above, according to the ceramic electrode structure and the ozone generator disclosed by the disclosure, the second ceramic body is bent to have the concave surface and the convex surface that are opposite to each other. The bent second ceramic body forms ozone gradient distribution and pressure difference in the reaction space between the ceramic electrode structure and the tungsten electrode, thereby providing ozone with high concentration in a specific region to meet the application in semiconductor fabrication.

Moreover, the inorganic bonding material including specific components has characteristics of high hardness, low melting point, being difficult to be decomposed by ozone and the like, which meets the manufacturing feasibility of the ceramic electrode structure and the application of the ozone generator in semiconductor fabrication.

Furthermore, since the inorganic bonding material has the component similar to ceramic, the bonding strength between the inorganic bonding material and the ceramic body is enhanced comparing to existing organic bonding material. In this way, the inorganic bonding material is prevented from being peeled from the ceramic body, and thus the lifespan of the ozone generator is prolonged.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A ceramic electrode structure, comprising:
a first ceramic body;
a second ceramic body, disposed to be corresponding to the first ceramic body;
a metal electrode, disposed between the first ceramic body and the second ceramic body; and
an inorganic bonding material, filled in a gap between the first ceramic body and the second ceramic body and surrounding the metal electrode;
wherein, the second ceramic body is bent to have a concave surface facing the first ceramic body and a convex surface that is opposite to the concave surface; and
wherein, a plurality of components of the inorganic bonding material comprise oxygen, sodium, magnesium, calcium, aluminum and silicon, a weight percentage of oxygen in the inorganic bonding material ranges from 30.0% to 50.0%, a weight percentage of sodium in the inorganic bonding material ranges from 10.0% to 20.0%, a weight percentage of magnesium in the inorganic bonding material is equal to or less than 10.0%, a weight percentage of calcium in the inorganic bonding material is equal to or less than 10.0%, a weight percentage of aluminum in the inorganic bonding material ranges from 1.0% to 5.0%, and a weight percentage of silicon in the inorganic bonding material is equal to or less than 30.0%.

2. The ceramic electrode structure according to claim 1, wherein the plurality of components of the inorganic bonding material further comprise at least one of zirconium, potassium and lead.

3. The ceramic electrode structure according to claim 1, wherein the weight percentage of magnesium in the inorganic bonding material ranges from 2.0% to 10.0%, and the weight percentage of calcium in the inorganic bonding material ranges from 2.0% to 10.0%.

4. The ceramic electrode structure according to claim 1, wherein the weight percentage of oxygen in the inorganic bonding material ranges from 30.0% to 40.0%, and the weight percentage of silicon in the inorganic bonding material ranges from 10.0% to 30.0%.

5. The ceramic electrode structure according to claim 1, wherein a melting point of the inorganic bonding material is lower than a melting point of the first ceramic body and a melting point of the second ceramic body.

6. The ceramic electrode structure according to claim 5, wherein the melting point of the inorganic bonding material is lower than 600.0° C., and the melting point of the first ceramic body and the melting point of the second ceramic body are higher than 600.0° C.

7. The ceramic electrode structure according to claim 1, wherein a vertical distance between a critical point of the convex surface of the second ceramic body and an edge of the convex surface ranges from 30.0 μm to 90.0 μm.

8. The ceramic electrode structure according to claim 1, wherein the first ceramic body, the metal electrode and the second ceramic body are sequentially disposed along a stacking direction, and a minimum thickness of the inorganic bonding material in the stacking direction ranges from 10.0 μm to 40.0 μm.

9. The ceramic electrode structure according to claim 1, wherein a Vickers hardness of the inorganic bonding material ranges from 1000.0 to 1500.0.

10. The ceramic electrode structure according to claim 1, wherein the first ceramic body, the metal electrode and the second ceramic body are sequentially disposed along a stacking direction, and a thickness of the first ceramic body in the stacking direction is larger than a thickness of the second ceramic body in the stacking direction.

11. The ceramic electrode structure according to claim 1, wherein the first ceramic body has a through hole, and a part of the metal electrode extends into the through hole.

12. The ceramic electrode structure according to claim 1, wherein the metal electrode comprises a first metal layer and a second metal layer that are in contact with each other, the first metal layer is bonded to the first ceramic body, and the second metal layer is bonded to the second ceramic body.

13. The ceramic electrode structure according to claim 12, wherein the metal electrode further comprises a third metal layer located between the first metal layer and the second metal layer, and a width of the third metal layer is smaller than a width of the first metal layer and a width of the second metal layer.

14. The ceramic electrode structure according to claim 12, wherein the first ceramic body has an inner surface facing the second ceramic body, and an orthogonal projection of the first metal layer onto the inner surface occupies 70.0% to 95.0% of the inner surface.

15. The ceramic electrode structure according to claim 12, wherein an orthogonal projection of the second metal layer onto the concave surface of the second ceramic body occupies 70.0% to 95.0% of the concave surface.

16. An ozone generator, comprising the ceramic electrode structure according to claim 1.
